(19) United States
(12) Patent Application Publication
(10) Pub. No.: US 2026/0200700 A1
(43) Pub. Date: Jul. 16, 2026

(54) ELEVATOR SAFETY ACTUATOR SYSTEMS

(71) Applicant: Otis Elevator Company, Farmington, CT (US)

(72) Inventor: Thomas Masayda, Watertown, CT (US)

(21) Appl. No.: 19/022,574

(22) Filed: Jan. 15, 2025

(51) Int. Cl. B66B 5/22

(52) U.S. Cl. CPC B66B 5/22

(57) ABSTRACT

Elevator systems include a traveling component and a guide rail within an elevator shaft. An overspeed safety system is operably connected to the traveling component and includes a brake assembly and an actuator assembly. A trigger element is configured to release stored energy of a stored energy device to cause engagement of a safety brake element with the guide rail to travel of the traveling component. When the safety brake element is engaged with the guide rail, upward motion of the traveling component causes the safety brake element to disengage from the guide rail and return the stored energy device to a state of stored energy.

### BACKGROUND

The subject matter disclosed herein generally relates to elevator systems and, more particularly, to safety systems for elevators and resetting of such safety systems after operation or actuation.

Typical elevator mechanical safety systems use governor overspeed systems coupled to a mechanical safety actuation module that is connected to a safety brake (or brakes) that activate in the event of a car overspeed event, car over-acceleration event, free fall, or the like. The elevator safety system will operate or actuate to stop motion of an elevator car that is travelling too fast. Such safety actuation modules include a linking mechanism to engage one or more car safety brakes simultaneously (e.g., on one or more respective guide rails associated with the elevator system). The governor is located either in a machine room, in the hoistway or elevator shaft, or may be mounted to the elevator car. After the elevator safety system is operated to stop movement of the elevator car, resetting of the elevator safety system may be necessary to allow the elevator car to resume normal operation, and to reset the safety system for future safety operations. Improving mechanisms for resetting such elevator safety systems may be beneficial, such as by reducing complexity and/or costs associated with such systems.

### BRIEF SUMMARY

According to some embodiments, elevator systems are provided. The elevator systems include a traveling component movable along a guide rail within an elevator shaft and an overspeed safety system operably connected to the traveling component. The overspeed safety system includes a brake assembly having a safety brake element configured to selectively and releasably engage with the guide rail and an actuator assembly including a linkage operably connected to the safety brake element at one end, a reset assembly operably connected to the linkage at an opposite end from the safety brake element, a stored energy device arranged to apply a biasing force to the linkage, and a trigger element arranged to selectively secure the stored energy device in a state of stored energy. The trigger element is configured to release the stored energy of the stored energy device to cause engagement of the safety brake element with the guide rail to stop downward travel of the traveling component along the guide rail in response to an overspeed event. When the safety brake element is engaged with the guide rail, upward motion of the traveling component causes the safety brake element to disengage from the guide rail and return the stored energy device to the state of stored energy.

In addition to one or more of the features described above, or as an alternative, further embodiments of the elevator systems may include that, after the stored energy device is returned to the state of stored energy, the trigger element is configured to be reengaged to maintain the stored energy device in the state of stored energy.

In addition to one or more of the features described above, or as an alternative, further embodiments of the elevator systems may include that the stored energy device is a spring.

In addition to one or more of the features described above, or as an alternative, further embodiments of the elevator systems may include that the brake assembly comprises a safety brake frame mounted to the traveling component, wherein the safety brake element is configured to travel along a guide surface of the safety brake frame to engage with the guide rail.

In addition to one or more of the features described above, or as an alternative, further embodiments of the elevator systems may include that the linkage is pivotably connected to the reset assembly.

In addition to one or more of the features described above, or as an alternative, further embodiments of the elevator systems may include that the reset assembly comprises a clamping device configured to selectively, releasably, and fixedly connect to the guide rail.

In addition to one or more of the features described above, or as an alternative, further embodiments of the elevator systems may include that the trigger element comprises a locking element that is extendable to maintain the stored energy device in the state of stored energy and the locking element is retractable to release the energy of the stored energy device.

In addition to one or more of the features described above, or as an alternative, further embodiments of the elevator systems may include that the trigger element is fixedly attached to the traveling component and the reset element is not fixedly attached to the traveling component.

In addition to one or more of the features described above, or as an alternative, further embodiments of the elevator systems may include that the traveling component is an elevator car or a counterweight for an elevator car.

In addition to one or more of the features described above, or as an alternative, further embodiments of the elevator systems may include that the brake assembly comprises two safety brake elements wherein each safety brake element is connected to the reset assembly by a respective linkage.

According to some embodiments, methods of operating elevator systems are provided. The methods include storing energy within a stored energy device of an overspeed safety system by retaining the stored energy device in a state of stored energy between a reset assembly of the overspeed safety system and a part of a traveling component, wherein the overspeed safety system comprises: a brake assembly comprising a safety brake element configured to selectively and releasably engage with a guide rail and an actuator assembly comprising a linkage operably connected to the safety brake element at one end and a reset assembly operably connected to the linkage at an opposite end from the safety brake element, wherein the stored energy device is arranged to apply a biasing force to the linkage, and a trigger element is arranged to selectively secure the stored energy device in a state of stored energy; detecting an overspeed event of the traveling component; operating the trigger element to release the reset assembly and the stored energy of the stored energy device to cause engagement of the safety brake elements with the guide rail to stop downward motion of the traveling component; engaging the guide rail with a part of the reset assembly to selectively and fixedly connect the reset assembly to the guide rail; moving the traveling component upward along the guide rail toward the reset assembly to return the stored energy device to a state of stored energy and to release engagement of the safety brake elements from the guide rail; and disengaging the part of the reset assembly that engaged with the guide rail to allow movement of the traveling component along the guide rail.

In addition to one or more of the features described above, or as an alternative, further embodiments of the methods may include that, after the stored energy device is returned to the state of stored energy, reengaging the trigger element to maintain the stored energy device in the state of stored energy.

In addition to one or more of the features described above, or as an alternative, further embodiments of the methods may include that the stored energy device is a spring.

In addition to one or more of the features described above, or as an alternative, further embodiments of the methods may include that the brake assembly comprises a safety brake frame mounted to the traveling component, wherein the safety brake element is configured to travel along a guide surface of the safety brake frame to engage with the guide rail.

In addition to one or more of the features described above, or as an alternative, further embodiments of the methods may include that the linkage is pivotably connected to the reset assembly.

In addition to one or more of the features described above, or as an alternative, further embodiments of the methods may include that the reset assembly comprises a clamping device configured to selectively, releasably, and fixedly connect to the guide rail.

In addition to one or more of the features described above, or as an alternative, further embodiments of the methods may include that the trigger element comprises a locking element that is extendable to maintain the stored energy device in the state of stored energy and the locking element is retractable to release the stored energy of the stored energy device.

In addition to one or more of the features described above, or as an alternative, further embodiments of the methods may include that the trigger element is fixedly attached to the traveling component and the reset element is not fixedly attached to the traveling component.

In addition to one or more of the features described above, or as an alternative, further embodiments of the methods may include that the traveling component is an elevator car or a counterweight for an elevator car.

In addition to one or more of the features described above, or as an alternative, further embodiments of the methods may include that the brake assembly comprises two safety brake elements wherein each safety brake element is connected to the reset assembly by a respective linkage.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited by the accompanying figures in which like reference numerals indicate similar elements.

FIG. 1 is a schematic illustration of an elevator system that may employ various embodiments of the present disclosure;

FIG. 2A illustrates an arrangement of an overspeed safety system for elevators in a first state of operation;

FIG. 2B illustrates the overspeed safety system of FIG. 2A in a second state of operation;

FIG. 2C illustrates the overspeed safety system of FIG. 2A in a third state of operation;

FIG. 3A is a schematic illustration of an overspeed safety system in accordance with an embodiment of the present disclosure shown in a normal state of operation;

FIG. 3B illustrates a stopping state of operation of the overspeed safety system of FIG. 3A;

FIG. 3C illustrates a resetting state of operation of the overspeed safety system of FIG. 3A;

FIG. 4 is a schematic illustration of another configuration of an overspeed safety system in accordance with an embodiment of the present disclosure; and

FIG. 5 is a flow process for operating an elevator system in accordance with an embodiment of the present disclosure.

### DETAILED DESCRIPTION

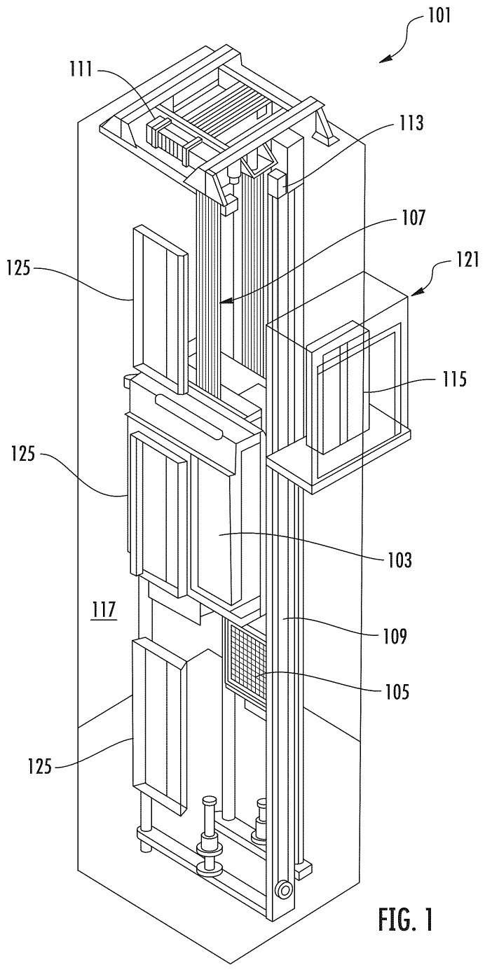

FIG. 1 is a perspective view of an elevator system 101 including an elevator car 103, a counterweight 105, a tension member 107, a guide rail 109, a machine 111, a position reference system 113, and an elevator controller 115. The elevator car 103 and counterweight 105 are connected to each other by the tension member 107. The tension member 107 may include or be configured as, for example, ropes, cables (e.g., steel cables), and/or belts (e.g., coated-steel belts). The counterweight 105 is configured to balance a load of the elevator car 103 and passengers and is configured to facilitate movement of the elevator car 103 concurrently and in an opposite direction with respect to the counterweight 105 within an elevator shaft 117 and along the guide rail 109. As used herein, the term “traveling component” refers to either of the elevator car 103 or the counterweight 105.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counterweight, as known in the art. For example, without limitation, the position reference system 113 can be an encoder, sensor, or other system and can include velocity sensing, absolute position sensing, etc., as will be appreciated by those of skill in the art.

The elevator controller 115 is located, as shown, in a controller room 121 of the elevator shaft 117 and is configured to control the operation of the elevator system 101, and particularly the elevator car 103. For example, the elevator controller 115 may provide drive signals to the machine 111 to control the acceleration, deceleration, leveling, stopping, etc. of the elevator car 103. The elevator controller 115 may also be configured to receive position signals from the position reference system 113 or any other desired position reference device. When moving up or down within the elevator shaft 117 along guide rail 109, the elevator car 103 may stop at one or more landings 125 as controlled by the elevator controller 115. Although shown in a controller room 121, those of skill in the art will appreciate that the elevator controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

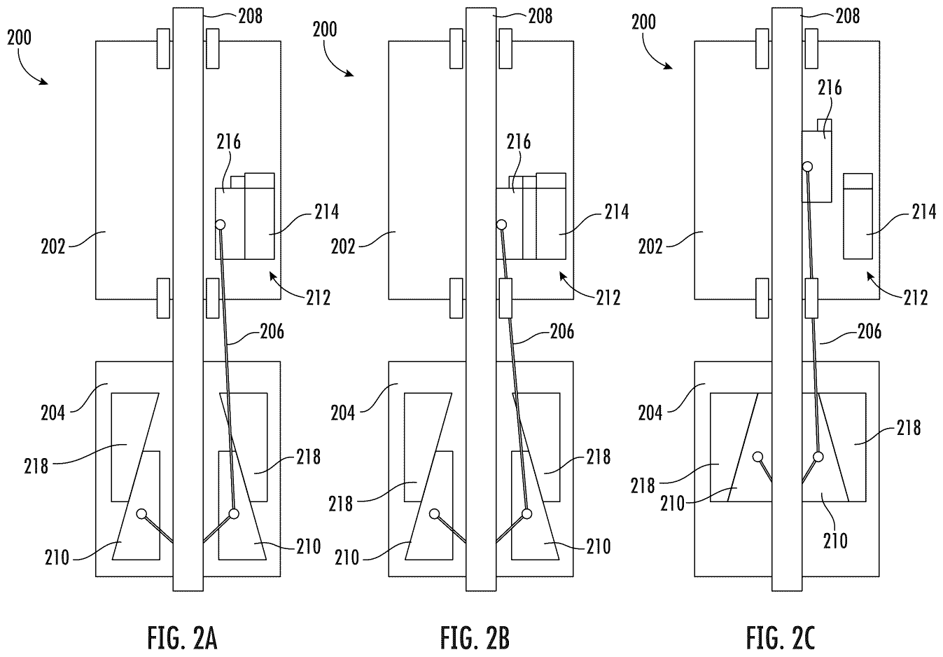

Turning now to FIGS. 2A-2C, an illustrative sequence of operation of a portion of an overspeed safety system 200 is shown. The overspeed safety system 200 includes an electromechanical actuator 202 and a safety brake 204 connected by a connecting link 206. The overspeed safety system 200 may be mounted to or otherwise attached to a traveling component (e.g., elevator car or counterweight). The safety brake 204 is arranged about a guide rail 208 and is configured to operably engage with the guide rail 208 to apply a braking force to the traveling component. The safety brake 204 includes safety brake elements 210 (e.g., brake pads, wedges, etc.) that are operable to engage with the guide rail 208. The electromechanical actuator 202 includes an actuator element 212 that is, in part, operably connected to the connecting link 206 to actuate the safety brake elements 210. FIG. 2A illustrates the overspeed safety system 200 is in a first state of operation, such as normal operation, where the traveling component, hereinafter referred to as an elevator car, is able to travel along the guide rail 208 freely. FIG. 2B illustrates a second state which occurs in response to an overspeed event, where the overspeed safety system 200 is partially actuated and partially engaged with the guide rail 208. FIG. 2C illustrates a third state of the overspeed safety system 200, with the overspeed safety system 200 fully engaged with the guide rail 208 and in a state that prevents downward motion or movement of the elevator car. It will be appreciated that the second state (FIG. 2B) may be a transient or transitional state that occurs very quickly in response to the overspeed event initiating operation of the overspeed safety system 200.

In this illustrative configuration, the actuator element 212 includes a first magnetic element 214 and a second magnetic element 216. The first magnetic element 214 may be an electromagnet (e.g., a coil) that generates a magnetic field to provide engagement with the second magnetic element 216. The second magnetic element 216 may be a permanent magnet. The states of the first and second magnetic elements 214, 216 are bi-stable and a current pulse is sent through the first magnetic element 214 for transitions between the first state (FIG. 2A) and second state (FIG. 2B) of the actuator element 212. The current polarity is used to control the direction of transition (i.e., first-to-second, or second-to-first). The above described operation is merely provided as example, and other arrangements are possible without departing from the scope of the present disclosure. In some embodiments, an electrical current may be provided to the first magnetic element to generate a repulsive magnetic field, and thus urge the second magnetic element away therefrom.

When the magnetic field of the first magnetic element 212 ceases to be generated, the second magnetic element 216 is moved into contact with and magnetically attaches to the guide rail 208, as shown in the middle image of FIG. 2 (second state). That is, because the first magnetic element 214 is no longer magnetized (e.g., no current flowing through a coil), the second magnetic element 216 will be attracted to the metal of the guide rail 208 and magnetically adhere thereto. Accordingly, when no electrical power is supplied to the first magnetic element 214, the second magnetic element 216 will automatically engage with the guide rail 216.

The second state, shown in the middle image of FIG. 2, exists when the elevator car is stationary or is representative of a transition state between the disengaged state (left image) and the actuated or engaged state (right image). In the second state (middle image), as the elevator car travels downward, and because the second magnetic element 216 is engaged with the guide rail 208, the second magnetic element 216 will apply a force to the connecting link 206 to urge the safety brake elements 210 into engagement with the guide rail 208 (third state, shown in right image of FIG. 2). With the safety brake elements 210 engaged with the guide rail 208, the elevator car may be prevented from further downward movement. As shown in FIG. 2, the safety brake elements 210 are arranged as wedges that can be pulled upward along angled blocks 218 to urge the safety brake elements 210 toward each other and to capture the guide rail 208 therebetween. The angled blocks 218 provide surfaces along which the safety brake elements 210 will travel and then be secured between the respective angled blocks 218 and the guide rail 208 such that a braking force or stopping force is applied to stop motion of the traveling component.

After operation and stopping of the elevator car by actuation of the overspeed safety system 200, the overspeed safety system 200 will need to be reset. When the overspeed safety system 200 is reset, the elevator car will be free to operate normally, traveling up and down along the guide rails through an elevator shaft of hoistway. There are various mechanisms for resetting such systems, using electronic, electrical, mechanical, and/or electromechanical mechanisms. However, such systems may be relatively complex or introduce failure points that can result in increased maintenance, failure of operation, or the like. Accordingly, improved safety systems may be beneficial for implementation within elevator systems.

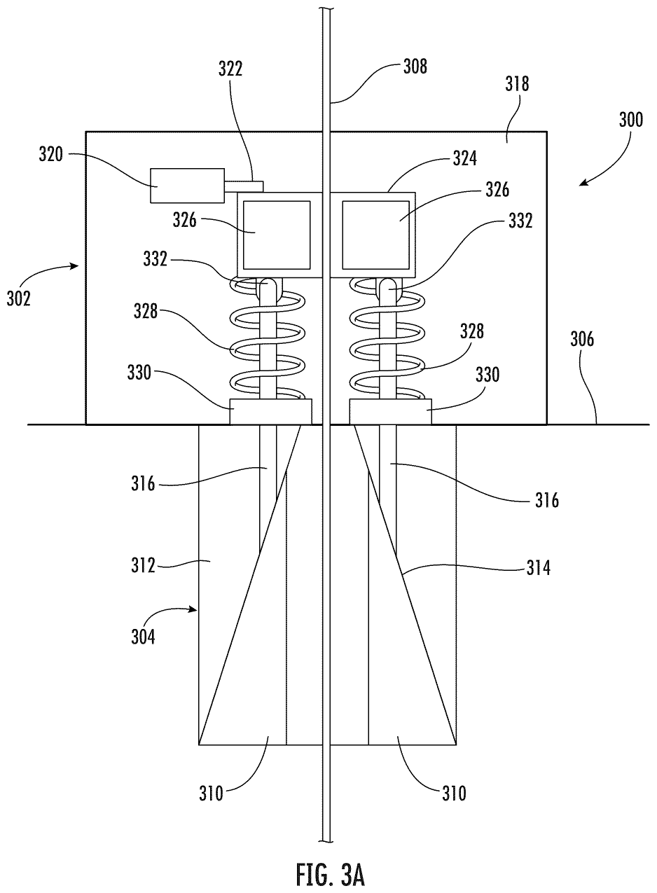

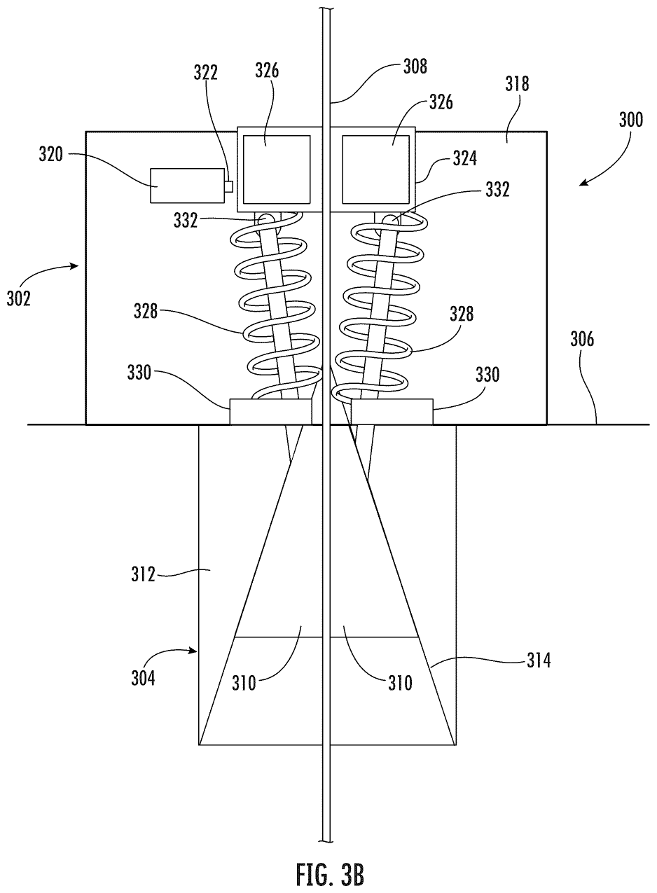

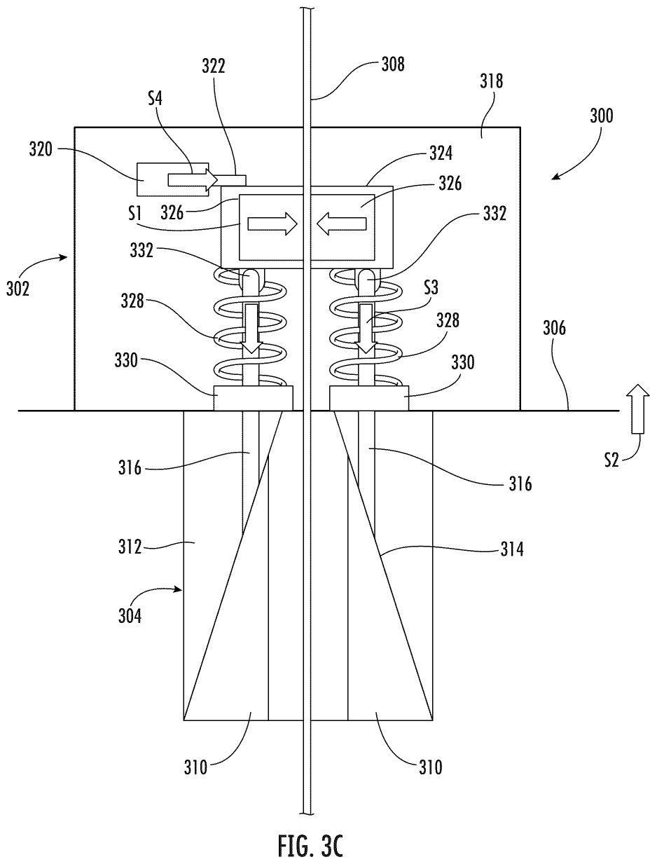

Referring now to FIGS. 3A-3C, schematic illustrations of an overspeed safety system 300 in accordance with an embodiment of the present disclosure are shown. FIG. 3A illustrates the overspeed safety system 300 in a normal state of operation, FIG. 3B illustrates a stopping state of operation of the overspeed safety system 300, and FIG. 3C illustrates a resetting state of operation of the overspeed safety system 300. The overspeed safety system 300 includes an actuator assembly 302 and a brake assembly 304. The overspeed safety system 300 is mounted or otherwise attached to an elevator car 306 (or other traveling component), and the elevator car 306 is configured to travel along a guide rail 308 within an elevator shaft or hoistway.

The overspeed safety system 300 is configured to provide an emergency braking operation for the elevator car 306, such as in response to an overspeed event. Similar to the above described embodiment in FIGS. 2A-2C, the brake assembly 304 includes a set of safety brake elements 310 (e.g., brake pads, wedges, etc.) arranged within a safety brake frame 312. The safety brake frame 312 includes guide surfaces 314 along which the safety brake elements 310 may travel during actuation of the overspeed safety system 300. The safety brake frame 312 is fixedly connected to the elevator car 306, such as to an elevator car frame or the like, as will be appreciated by those of skill in the art. The guide surfaces 314 are tapered or otherwise angled to narrow in separation distance to provide a guide for the safety brake elements 310 to follow and be urged into engagement with a guide rail 308. That is, as the safety brake elements 310 are moved during actuation, as described herein, the safety brake elements 310 are pulled or moved along the guide surfaces 314 to pinch or engage on opposite sides of the guide rail 308 to apply a braking force (e.g., frictional force), as shown in FIG. 3B.

The overspeed safety system 300 includes respective linkages 316 that operably connect the safety brake elements 310 to the actuator assembly 302. The actuator assembly 302 includes an actuator frame 318 that is affixed to the elevator car 306. Fixedly attached to or mounted on the actuator frame 318 is a trigger element 320 that includes a locking element 322. The trigger element 320 may be an electromagnet, a solenoid, or other electrical, mechanical, or electromechanical device that can be operated or actuated in response to an overspeed event, similar, for example, to the magnetic operation described with respect to FIGS. 2A-2C. The locking element 322 of the trigger element 320 is configured to be normally extended (e.g., as shown in FIGS. 3A, 3C) and is arranged to hold a reset assembly 324 in place. The reset assembly 324 is part of the actuator assembly 302 but is not fixedly attached to the actuator frame 318. Rather, the reset assembly 324 is arranged at ends of the linkages 316 opposite from the safety brake elements 310. The reset assembly 324 may be arranged as a housing or the like that includes clamping elements 326 therein. Operation of the clamping elements 326 will be described herein with respect to operation of the overspeed safety system 300. The reset assembly 324 is normally retained under load by compressing one or more stored energy devices 328. The stored energy devices 328 may be compressed springs, biasing elements, pistons, hydraulic or pneumatic elements, or the like. As illustrated, the stored energy devices 328 are shown as springs. The stored energy devices 328 are fixedly connected or attached to the elevator car 306 and/or the actuator frame 318 at a first end 330. The first end 330 may include a base or structure to attach the stored energy devices 328 and allow for the linkages 316 to pass therethrough. At a second end 332, the stored energy devices 328 are pivotably connected, fixedly connected, or otherwise attached to the reset assembly 324 (e.g., by bonding, adhesive, welding, use of fasteners, etc.). The locking element 322 is selected to ensure that in normal operation, the stored energy devices 328 are maintained under compression by securing the reset assembly 324 in place, as shown in FIG. 3A.

FIG. 3B illustrates the overspeed safety system 300 in an actuated or engaged state, such as performed in response to an overspeed event. Upon detection of an overspeed event, using conventional detection mechanisms (e.g., governor, digital sensors, sensors on an elevator machine or elevator car, etc.), the trigger element 320 may receive instructions to operate the locking element 322. The instructions may be as simple as an electrical signal powering the trigger element 320 to retract the locking element 322, or the breaking of an electric circuit (e.g., electrical safety chain) or the like. When the trigger element 320 is operated in response to the overspeed event, the locking element 322 is retracted and removed from blocking movement of the reset assembly 324. With the removal of the locking element 322, the stored energy devices 328 are free to expand, extend, or otherwise deploy from the compressed state (FIG. 3A) to an extended state (FIG. 3B).

As the stored energy devices 328 extend (after removal of the block provided by the locking element 322), the stored energy devices 328 will urge the reset assembly 324 upward and in a direction away from the safety brake frame 312. As the reset assembly 324 is urged upward, the reset assembly 324 will pull on the linkages 316 which in turn apply an upward force on the safety brake elements 310. As the safety brake elements 310 are pulled or moved upward, the safety brake elements 310 will travel along the guide surfaces 314. The safety brake elements 310 will thus move toward each other and clamp or otherwise engage with the guide rail 308. When the safety brake elements 310 are engaged with the guide rail 308, as shown in FIG. 3B, downward motion of the elevator car 306 is prevented, thus stopping travel of the elevator car 306.

After the elevator car 306 is stopped, the overspeed safety system 300 must be reset to allow for normal operation of the elevator car 306. During the reset operation, which is schematically shown in FIG. 3C, a series of steps is performed to bring the elevator system back into a normal state of operation. It is noted that the reset operation is performed after an actuation or operation that engages the safety brake elements 310 with the guide rail 308. During the reset operation, the safety brake elements 310 are disengaged from the guide rail 308, the stored energy devices 328 are compressed and returned to an under-load condition (e.g., stored energy), and the locking element 322 will extend to secure the reset assembly 324.

For example, with reference to FIG. 3C, at a first step, the clamping elements 326 of the reset assembly 324 engage with the guide rail 308, as illustrated by arrows S1. The clamping elements 326 may be magnets, gripping structures, structures with friction surfaces, or the like for temporarily and selectively fixedly engaging with the guide rail 308. The clamping elements 326 are configured to apply a clamping force to engage with the guide rail 308. In some configurations, the clamping elements 326 may be arranged to be driven (e.g., pneumatically, hydraulically, electrically, electromechanically, mechanically, or the like) into engagement with the guide rail 308 and apply a clamping force thereto. For example, in some embodiments, the clamping elements 326 may be arranged on pistons, shafts, or other linear structure that may be driven by a solenoid to apply a clamping force to the guide rail 308. In other embodiments, the clamping elements 326 may be electromagnets that are supplied with electrical current to energize and magnetically engage with the guide rail 308. It will be appreciated that other mechanisms may be used for selectively and releasably engaging the clamping elements 326 to the guide rail 308.

Next, as indicated at arrow S2, the elevator car 306 is moved upward along the guide rail 308, such as by operation of an elevator machine (e.g., machine 111 shown in FIG. 1). This travel of the elevator car 306 will cause the safety brake frame 312 to move upward. Because the safety brake elements 310 are engaged with the guide rail 308, as the safety brake frame 312 travels upward along the guide rail 308, the compression from the guide surfaces 314 will be released, and the safety brake elements 310 may disengage from the guide rail 308. At the same time, because the clamping elements 326 are engaged with the guide rail 308, the reset assembly 324 will remain stationary, and the elevator car 306 will move toward and closer to the reset assembly 324. During this operation, the stored energy devices 328 will be compressed between the reset assembly 324 and the elevator car 306 (or the base/structure at the first end 330 of the stored energy devices 328), as indicated by arrows S3.

Once the stored energy devices 328 are fully compressed, and the reset assembly 324 is moved downward relative to the trigger element 320, the locking element 322 may extend to secure the reset assembly 324 in place and to maintain the compression of the stored energy devices 328, as indicated by arrow S4. After the locking element 322 is extended and arranged to secure the reset assembly 324, the clamping elements 326 may be released from engagement with the guide rail 308, returning the overspeed safety system 300 to the normal operational state of the elevator car 306 (e.g., as shown in FIG. 3A).

As will be appreciated by the above description, the resetting of the overspeed safety system 300 is performed by the upward motion of the elevator car 306. That is, in addition to releasing the safety brake elements 310 from engagement with the guide rail 308, the upward travel of the elevator car 306 will also reset the overspeed safety system 300. By moving the elevator car 306 upward, when the clamping elements 326 are engaged with the guide rail 308, the stored energy devices 328 may be compressed to re-energize the stored energy devices 328. In accordance with embodiments of the present disclosure, the stored energy devices 328 are maintained under compression and are energized during normal elevator system operation. Due to the energized state of the stored energy devices 328, by releasing the locking element 322, the stored energy devices 328 will automatically release the stored energy to extend and cause actuation and engagement of the safety brake elements 310 with the guide rail 308.

In view of the above, it will be appreciated that various different configurations of the components of the overspeed safety systems disclosed herein may be employed without departing from the scope of the present disclosure. For example, and without limitation, some configurations can include ratcheted linkages that are free to move until the reset operation, at which point the ratchet configuration will compress and reset the stored energy devices to a stored energy state. The linkages in other embodiments may be pistons, linear actuators, or the like.

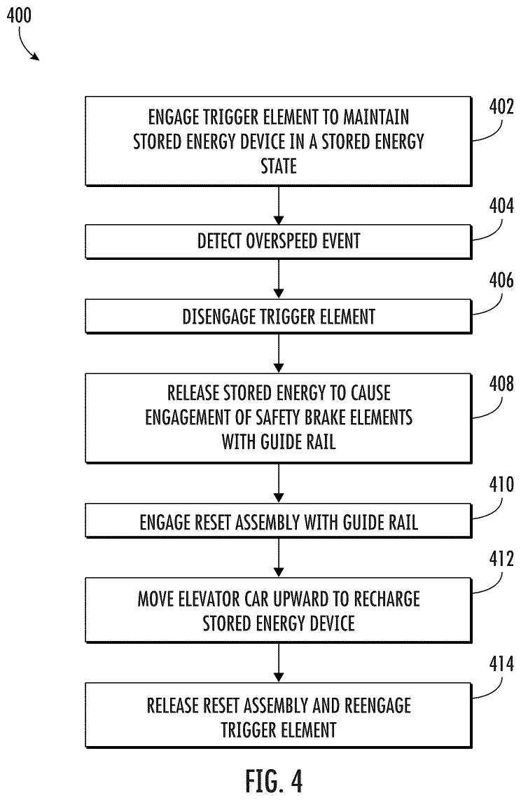

Referring now to FIG. 4, a flow process 400 for operating an elevator system, in accordance with the present disclosure, is shown. The flow process 400 may be employed using the overspeed safety systems shown and described herein and similar such systems, as will be appreciated by those of skill in the art in view of the teachings herein.

At step 402, a trigger element is engaged to maintain one or more stored energy devices in a stored energy state. The stored energy state may be a spring under compression, compression of a piston or the like that is normally biased when the trigger element is engaged, or the like. The state of the system at step 402 is a normal state of operation, allowing for an elevator car to freely travel along a guide rail.

At step 404, an overspeed event is detected. The detection of the overspeed event may be performed using an elevator governor, which may be machine or car mounted. In other configurations, or in combination therewith, optical, proximity, or other sensors may be used for detection of overspeed events. In still further configurations, or in combination therewith, the overspeed event may be detected using other methods and/or mechanisms in the art.

At step 406, in response to detection of the overspeed event, the trigger element is disengaged from the stored energy device(s). The disengagement of the trigger element may be by a break in an electronic safety chain, supply of energy to the trigger element, a mechanical switch, an electromechanical switch, or the like. By removing a power supply (or providing power depending on the specific configuration), the trigger element may be retracted from engagement to allow for the release of the stored energy, at step 408.

At step 408, as the stored energy of the stored energy device(s) is released, the stored energy devices will urge safety brake elements to move into braking engagement with a guide rail. For example, as the stored energy is released, the stored energy devices will cause linkages to pull upward on safety brake elements, which causes the safety brake elements move into contact with the guide rail to brake motion of the elevator car.

Once it is desired to resume normal operation of the elevator car, the overspeed safety systems must be disengaged from the guide rail to allow for free travel of the elevator car. Accordingly, at step 410, a reset element of the overspeed safety system is engaged with the guide rail. The reset element may be a clamp or clamp system, a ratchet system, or the like, as will be appreciated by those of skill in the art. The reset element provides for a temporary fixed engagement between a part of the overspeed safety system and the guide rail.

At step 412, with the reset element engaged with the guide rail, the elevator car may be moved upward along the guide rail. Because the reset element is fixedly engaged with the guide rail, as the elevator car is moved upward along the guide rail, the stored energy device will be compressed and energy will be input into the stored energy device. That is, moving the elevator car upward during the resetting operation will automatically recharge the stored energy device such that it will be charged for the next overspeed event.

At step 414, with the stored energy device recharged, the reset element may be disengaged from the guide rail, thus restoring the overspeed safety system back to the normal operational mode or state. During the release of the reset element at step 414, the trigger element is reengaged to maintain the stored energy device in the stored energy state. In this state, the elevator car is free to travel along the guide rail.

Advantageously, embodiments described herein provide for elevator safety systems that are configured to provide emergency stopping or braking with simple resetting operations. For example, in accordance with embodiments of the present disclosure, during a resetting operation of an overspeed safety system, the system may be reset by upward travel of an elevator car. The upward travel of the elevator car in combination with the features of the overspeed safety system causes a stored energy device to be compressed or otherwise store energy. As such, during the return to normal operation, the safety system may be reset without additional or separate energy input (e.g., motor, linear actuator, etc.). Advantageously, the reset operation is built into the safety system, avoiding the need for additional electronics or components to be used for resetting after an overspeed event.

The terminology used herein is for the purpose of describing particular embodiments only and is not intended to be limiting of the present disclosure. The term “about” is intended to include the degree of error associated with measurement of the particular quantity and/or manufacturing tolerances based upon the equipment available at the time of filing the application. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. An elevator system comprising:
a traveling component movable along a guide rail within an elevator shaft; and
an overspeed safety system operably connected to the traveling component, the overspeed safety system comprising:
a brake assembly comprising a safety brake element configured to selectively and releasably engage with the guide rail; and
an actuator assembly comprising:
a linkage operably connected to the safety brake element at one end and configured to apply a force on the safety brake element during a braking event;
a reset assembly operably connected to the linkage at an opposite end from the safety brake element;
a stored energy device arranged to apply a biasing force to the linkage to cause the linkage to apply the force to the safety brake element; and
a trigger element arranged to selectively secure the stored energy device in a state of stored energy;
wherein the trigger element is configured to release the stored energy of the stored energy device to cause the linkage to apply the force to the safety brake element and cause engagement of the safety brake element with the guide rail to stop downward travel of the traveling component along the guide rail in response to an overspeed event,
wherein, when the safety brake element is engaged with the guide rail, upward motion of the traveling component causes the safety brake element to disengage from the guide rail and return the stored energy device to the state of stored energy.

2. The elevator system of claim 1, wherein, after the stored energy device is returned to the state of stored energy, the trigger element is configured to be reengaged to maintain the stored energy device in the state of stored energy.

3. The elevator system of claim 1, wherein the stored energy device is a spring.

4. The elevator system of claim 1, wherein the brake assembly comprises a safety brake frame mounted to the traveling component, wherein the safety brake element is configured to travel along a guide surface of the safety brake frame to engage with the guide rail.

5. The elevator system of claim 1, wherein the linkage is pivotably connected to the reset assembly.

6. The elevator system of claim 1, wherein the reset assembly comprises a clamping device configured to selectively, releasably, and fixedly connect to the guide rail.

7. The elevator system of claim 1, wherein the trigger element comprises a locking element that is extendable to maintain the stored energy device in the state of stored energy and the locking element is retractable to release the energy of the stored energy device.

8. The elevator system of claim 1, wherein the trigger element is fixedly attached to the traveling component and the reset element is not fixedly attached to the traveling component.

9. The elevator system of claim 1, wherein the traveling component is an elevator car or a counterweight for an elevator car.

10. The elevator system of claim 1, wherein the brake assembly comprises two safety brake elements wherein each safety brake element is connected to the reset assembly by a respective linkage.

11. A method of operating an elevator system, the method comprising:
storing energy within a stored energy device of an overspeed safety system by retaining the stored energy device in a state of stored energy between a reset assembly of the overspeed safety system and a part of a traveling component, wherein the overspeed safety system comprises: a brake assembly comprising a safety brake element configured to selectively and releasably engage with a guide rail and an actuator assembly comprising a linkage operably connected to the safety brake element at one end and configured to apply a force on the safety brake element during a braking event and a reset assembly operably connected to the linkage at an opposite end from the safety brake element, wherein the stored energy device is arranged to apply a biasing force to the linkage to cause the linkage to apply the force to the safety brake element, and a trigger element is arranged to selectively secure the stored energy device in a state of stored energy;
detecting an overspeed event of the traveling component;
operating the trigger element to release the reset assembly and the stored energy of the stored energy device to cause the linkage to apply the force to the safety brake element and cause engagement of the safety brake elements with the guide rail to stop downward motion of the traveling component;
engaging the guide rail with a part of the reset assembly to selectively and fixedly connect the reset assembly to the guide rail;
moving the traveling component upward along the guide rail toward the reset assembly to return the stored energy device to a state of stored energy and to release engagement of the safety brake elements from the guide rail; and
disengaging the part of the reset assembly that engaged with the guide rail to allow movement of the traveling component along the guide rail.

12. The method of claim 11, wherein, after the stored energy device is returned to the state of stored energy, reengaging the trigger element to maintain the stored energy device in the state of stored energy.

13. The method of claim 11, wherein the stored energy device is a spring.

14. The method of claim 11, wherein the brake assembly comprises a safety brake frame mounted to the traveling component, wherein the safety brake element is configured to travel along a guide surface of the safety brake frame to engage with the guide rail.

15. The method of claim 11, wherein the linkage is pivotably connected to the reset assembly.

16. The method of claim 11, wherein the reset assembly comprises a clamping device configured to selectively, releasably, and fixedly connect to the guide rail.

17. The method of claim 11, wherein the trigger element comprises a locking element that is extendable to maintain the stored energy device in the state of stored energy and the locking element is retractable to release the stored energy of the stored energy device.

18. The method of claim 11, wherein the trigger element is fixedly attached to the traveling component and the reset element is not fixedly attached to the traveling component.

19. The method of claim 11, wherein the traveling component is an elevator car or a counterweight for an elevator car.

20. The method of claim 11, wherein the brake assembly comprises two safety brake elements wherein each safety brake element is connected to the reset assembly by a respective linkage.
